(19) United States
(12) Patent Application Publication
(10) Pub. No.: US 2014/0118598 A1
(43) Pub. Date: May 1, 2014

(54) PHOTOGRAPHING APPARATUS AND METHOD OF CONTROLLING THE SAME

(71) Applicant: SAMSUNG ELECTRONICS CO., LTD., Suwon-si (KR)

(72) Inventor: Dong-su Kim, Anyang-si (KR)

(73) Assignee: SAMSUNG ELECTRONICS CO., LTD., Suwon-si (KR)

(21) Appl. No.: 14/062,122

(22) Filed: Oct. 24, 2013

(30) Foreign Application Priority Data
Oct. 25, 2012 (KR) 10-2012-0119196

(51) Int. Cl. H04N 5/232

(52) U.S. Cl. CPC H04N 5/23216
USPC 348/333.02

(57) ABSTRACT

A photographing apparatus and a method of controlling the same are provided. The photographing apparatus includes a display unit which displays an image, an input unit via which a command is input, and a control unit which controls the display unit to display icons representing changed settings of the photographing apparatus on a predetermined region of the display unit when settings of the photographing apparatus are changed according to an input command that is input via the input unit. Accordingly, the photographing apparatus is capable of providing a user with a changed function setting among function settings.

### CROSS-REFERENCE TO RELATED APPLICATIONS

This application claims priority from Korean Patent Application No. 10-2012-0119196, filed on Oct. 25, 2012, in the Korean Intellectual Property Office, the disclosure of which is incorporated herein by reference in its entirety.

### BACKGROUND

1. Field

Apparatuses and methods consistent with various embodiments of the invention relate to a photographing apparatus and a method of controlling the same, and more particularly, to a photographing apparatus capable of providing information related to photographing details through a live view and a method of controlling the same.

2. Related Art

When a live view mode is activated, a conventional photographing apparatus, such as a digital camera, displays an image of an object, which is to be captured, through the live view mode. Together with the displaying of the image, the conventional photographing apparatus displays a plurality of icons representing a photographing mode of the image and function settings of the conventional photographing apparatus, on a region of a live view image displayed thereon. Thus, a user is able to set a desired photographing mode or a desired function of the conventional photographing apparatus by selecting one of the plurality of icons displayed on the region of the live view image.

However, when another user captures an image by using the conventional photographing apparatus after a function setting of the conventional photographing apparatus has been changed by the user as described above, the other user cannot detect or recognize the changed function setting in the live view mode. Also, when the other user discovers that the image was captured in an undesired state and that a function setting was changed, the other user will feel inconvenienced since he or she has to access a menu item related to the function setting to change the changed function setting.

### SUMMARY

Exemplary embodiments of the invention may overcome the above disadvantages and other disadvantages not described above. Also, the invention is not required to overcome the disadvantages described above, and an exemplary embodiment of the invention may not overcome any of the problems described above.

Various embodiments provide information regarding a changed function setting of a photographing apparatus.

According to an embodiment, a photographing apparatus includes a display unit which displays an image; an input unit via which a command is input; and a control unit which controls the display unit to display changed-setting icons representing changed settings of the photographing apparatus on a predetermined region of the display unit, when the settings of the photographing apparatus are changed according to an input command.

While a live view image is displayed, the display unit may display at least one setting icon corresponding to a setting of the photographing apparatus on a first region of the live view image. When a setting corresponding to one of the at least one setting icon displayed on the first region is changed according to an input command, the control unit may control the display unit to display a changed-setting icon representing the changed setting on a second region of the live view image, the second region being different from the first region.

While a live view image is displayed, the display unit may display at least one setting icon corresponding to a setting of the photographing apparatus on a first region of the live view image. When a setting corresponding to an icon that is not displayed on the first region is changed according to an input command, the control unit may generate a changed-setting icon representing the changed setting and control the display unit to display the generated changed-setting icon on a second region of the live view image, the second region being different from the first region.

The control unit may control the display unit to display a plurality of changed-setting icons representing the changed settings on the second region, in the order in which the settings have been changed.

When a selection command instructing selection of at least one changed-setting icon displayed on the second region is input, the control unit may initialize a setting of the at least one changed-setting icon corresponding to the selection command.

When a selection command instructing selection of at least one changed-setting icon displayed on the second region is input, the control unit may control the display unit to display a function setting menu list related to the at least one changed-setting icon corresponding to the selection command.

When a selection command instructing selection of a remaining region of the live view image different from the first and second regions is input, the control unit may control the display unit to stop displaying the icons that are displayed on the first and second regions.

When a selection command instructing selection of a remaining region of the live view image different from the first and second regions is input, the control unit controls the display unit to stop displaying the icons that are displayed on the first and second regions, except for an icon corresponding to a preset condition.

When a selection command instructing selection of at least one of the first and second regions is input, the control unit may control the display unit to stop displaying icons that are displayed on the at least one region corresponding to the selection command.

After the display unit has stopped displaying at least one icon of the icons displayed on the first and second regions according to the selection command, when a second selection command instructing selection of a remaining region of the live view image different from the first and second regions is input, the control unit may control the display unit to redisplay the at least one icon.

According to an embodiment, a method of controlling a photographing apparatus includes receiving an input command, changing settings of the photographing apparatus according to the input command; generating changed-setting icons representing the changed settings; and displaying the changed-setting icons on a predetermined region of a display unit.

The method may further include, while displaying a live view image, displaying at least one setting icon corresponding to a setting of the photographing apparatus on a first region of the live view image. When a setting corresponding to one of the at least one setting icon displayed on the first region is changed according to the input command, the displaying of the changed-setting icons on the predetermined region may include displaying a changed-setting icon representing the changed setting on a second region of the live view image, the second region being different from the first region.

The method may further include, while displaying a live view image, displaying at least one setting icon corresponding to a setting of the photographing apparatus on a first region of the live view image. When a setting corresponding to an icon that is not displayed on the first region is changed according to the input command, the displaying of the changed-setting icons on the predetermined region may include generating a changed-setting icon representing the changed setting and displaying the generated changed-setting icon on a second region of the live view image, the second region being different from the first region.

The displaying of the changed-setting icons on the predetermined region may include displaying the changed-setting icons on the second region, in the order in which the settings have been changed.

The method may further include, when a selection command instructing selection of at least one changed-setting icon displayed on the second region is input, initializing a setting of the at least one changed-setting icon corresponding to the selection command.

The method may further include, when a selection command instructing selection of at least one changed-setting icon displayed on the second region is input, displaying a function setting menu list related to the at least one changed-setting icon corresponding to the selection command.

The method may further include, when a selection command instructing to select a remaining region of the live view image different from the first and second regions is input, stop displaying the icons that are displayed on the first and second regions.

The method may further include, when a selection command instructing selection of a remaining region of the live view image different from the first and second regions is input, stop displaying the icons that are displayed on the first and second regions, except for an icon corresponding to a preset condition.

The method may further include, when a selection command instructing selection of at least one of the first and second regions is input, stop displaying icons that are displayed on the at least one region corresponding to the selection command.

The method may further include, after at least one icon of the icons on the first and second regions is no longer displayed on the live view image according to the selection comment, when a second selection command instructing selection of the remaining region of the live view, redisplaying the at least one icon.

According to various embodiments as described above, a photographing apparatus is capable of providing an icon representing a changed function setting among function settings thereof, thereby enabling a user to easily check the changed function setting.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects of the invention will be more apparent by describing certain exemplary embodiments with reference to the accompanying drawings, in which:

FIG. 1 is a block diagram of a photographing apparatus, according to an embodiment;

FIG. 2 is a detailed block diagram of a photographing unit that captures an image, included in a photographing apparatus, according to an embodiment;

FIG. 3 is a diagram illustrating icons representing function settings on a live view image displayed on a photographing apparatus, according to an embodiment;

FIG. 4 is a diagram illustrating icons representing function settings and icons indicating changed function settings on a live view image displayed on a photographing apparatus, according to another embodiment;

FIG. 5 is a diagram illustrating performing an additional function related to at least one of a plurality of icons displayed on a live view image on a photographing apparatus, according to an embodiment;

FIG. 6 is a diagram illustrating performing an additional function related to at least one of a plurality of icons displayed on a live view image on a photographing apparatus, according to another embodiment;

FIG. 7 is a diagram illustrating performing an additional function according to a selection command instructing selection a remaining region of a live view image different from a first region and a second region, on a photographing apparatus, according to another embodiment; and

FIG. 8 is a flowchart illustrating a method of providing icons representing function settings on a live view image displayed on a photographing apparatus, according to an embodiment.

### DETAILED DESCRIPTION

Certain exemplary embodiments of the invention will now be described in greater detail with reference to the accompanying drawings.

In the following description, same drawing reference characters are used for the same elements even in different drawings. The matters defined in the description, such as detailed construction and elements, are provided to assist in a comprehensive understanding of the invention. Thus, it is apparent that the exemplary embodiments can be carried out without those specifically defined matters. Also, well-known functions or constructions are not described in detail since they would obscure the invention with unnecessary detail.

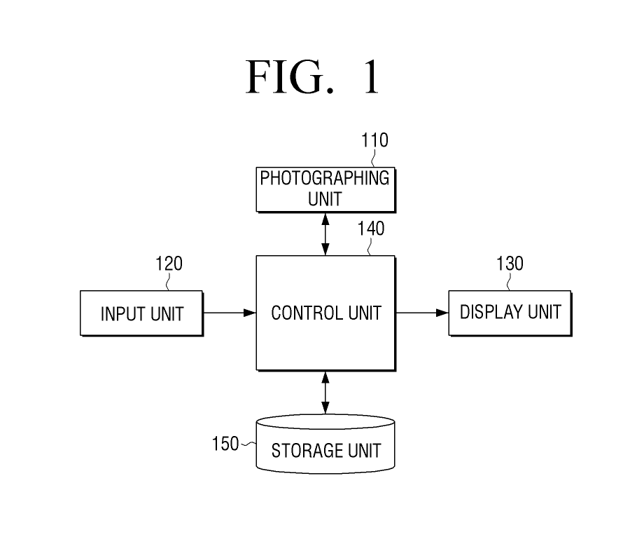

FIG. 1 is a block diagram of a photographing apparatus, according to an embodiment.

Referring to FIG. 1, the photographing apparatus includes a photographing unit 110, an input unit 120, a display unit 130, a control unit 140, and a storage unit 150. The photographing apparatus as described above may be a digital camera. However, the invention is not limited thereto, and the photographing apparatus may be any apparatus having a photographing function, such as a smart phone.

The photographing unit 110 is configured to capture an image. Specifically, the photographing unit 110 transforms a light signal input via a lens into an electrical signal, and performs signal processing thereon to generate an image signal. The operation of the photographing unit 110 will be described in detail below.

Various user commands may be input via the input unit 120. Although not shown, the input unit 120 may include a power button configured to power the photographing apparatus on or off, a shutter via which an image capture command is input, a manipulation button configured to change settings of the photographing apparatus, and a touch screen.

The display unit 130 displays an image of an object through a live view mode. Also, the display unit 130 displays icons representing changed settings of the photographing apparatus and an operating state of the photographing apparatus, e.g., remaining battery power, through the live view mode.

When a setting of the photographing apparatus is changed according to a user command that is input via the input unit 120, the control unit 140, which controls overall operations of the elements of the photographing apparatus, generates an icon representing the changed setting and controls the display unit 130 to display the icon on a predetermined region of the display unit 130. While a live view image is displayed on the display unit 130, the control unit 140 may control the display unit 130 to display icons representing function settings on the predetermined region. The display unit 130 may display the icons representing the function settings on the predetermined region, under control of the control unit 140. Here, the function settings corresponding to the icons may each be initialized, or reset, to have a default value.

A user may select an icon that is displayed on or that is not displayed on the live view image, and change the function setting corresponding to this icon. When the function setting is changed, the control unit 140 may generate an icon representing the changed function setting, and control the display unit 130 to display the icon on a specific region of the display unit 130.

Thus, the display unit 130 may display the icon representing the changed function setting on a region different from the region on which the icons representing the function settings are displayed. Accordingly, a user may check a changed function of the photographing apparatus based on the icons displayed on the live view image. A process of providing an icon representing a changed function setting of the photographing apparatus as described above will be described in more detail below.

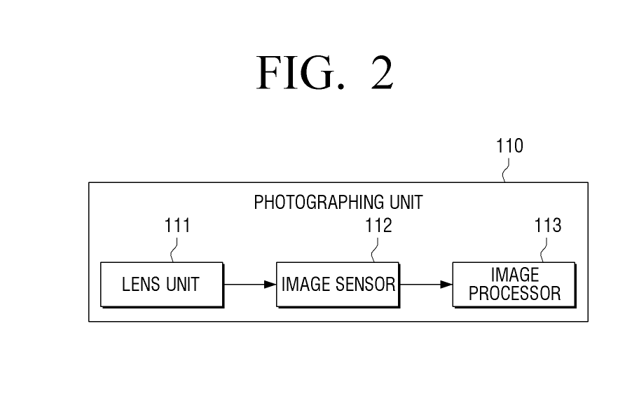

The photographing unit 110 configured to capture an image of an object as described above may be embodied as illustrated in FIG. 2. The structure of the photographing unit 110 that captures an image will now be described in detail.

FIG. 2 is a detailed block diagram of the photographing unit 110 that captures an image, included in the photographing apparatus illustrated in FIG. 1, according to an embodiment.

Referring to FIG. 2, the photographing unit 110 includes a lens unit 111, an image sensor 112, and an image processor 113. A light signal of an object that is to be photographed is incident on the lens unit 111. The lens unit 111 may be a barrel type lens that protrudes outwardly or an inner-zoom type lens that protrudes inwardly. Otherwise, the lens unit 111 may be a lens that is detachable and attachable, such as that of a digital single-lens reflex (DSLR) camera.

When the light signal is incident on the image sensor 112 via the lens unit 111, the image sensor 112 transforms the light signal into an electrical signal by using an image capturing device (not shown), such as a charge-coupled device (CCD) or a complementary metal oxide semiconductor (CMOS), performs signal processing on the electrical signal to obtain an image signal, and outputs the image signal to the image processor 113. Then, the image processor 113 performs signal processing on the image signal that is input from the image sensor 112 to obtain an image. Thus, the display unit 130 may display the image generated by the image processor 113 when displaying a live view image.

As described above, while the live view image is displayed, the display unit 130 may display icons representing function settings of the photographing apparatus and an icon representing a changed function setting, on the live view image.

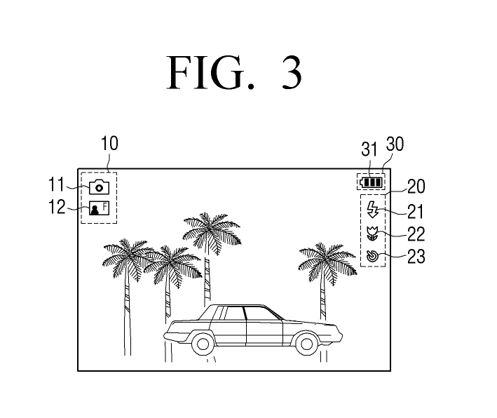

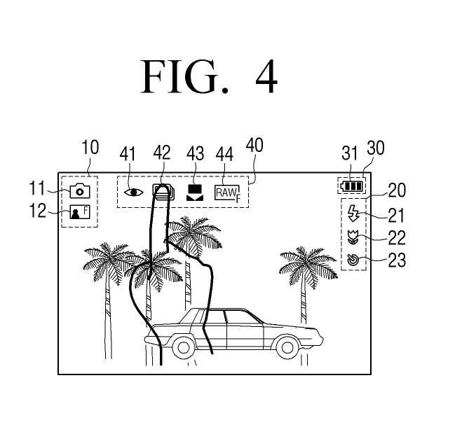

FIG. 3 is a diagram illustrating displaying icons representing function settings on a live view image displayed on a photographing apparatus, according to an embodiment. FIG. 4 is a diagram illustrating displaying icons representing function settings and icons indicating changed function settings on a live view image displayed on a photographing apparatus, according to another embodiment.

As illustrated in FIG. 3, the display unit 130 displays an image of an object captured by the photographing unit 110 on a live view image, under control of the control unit 140. While displaying of the image, the display unit 130 displays at least one icon corresponding to settings of the photographing apparatus on first regions 10 and 20 of the live view image, under control of the control unit 140. The at least one icon corresponding to the settings of the photographing apparatus is at least one icon representing function settings of the photographing apparatus. According to another embodiment, the display unit 130 may display a plurality of icons representing function settings on the first regions 10 and 20, which may be a left region and a right region of the live view image.

More specifically, an icon 11 representing an image shooting type and an icon 12 representing a storage time setting among the plurality of icons may be displayed on the first region 10 (left region) of the first regions 10 and 20 of the live view image. An icon 21 representing a flash mode setting, an icon 22 representing a color setting, and an icon 23 representing an automatic shutter setting may be displayed on the first region 20 (right region). The function settings corresponding to the plurality of icons displayed on the left and right regions 10 and 20 may be initialized, or reset, to have default values. Additionally, the display unit 130 may display an icon 31 representing an operating state of the photographing apparatus on a third region 30 of the live view image.

A user may select either at least one of the icons 11, 12, 21, 22, and 23 representing the function settings of the photographing apparatus that are displayed on the live view image, or an icon that represents a function setting of the photographing apparatus that is not displayed on the live view image, and may then change the function setting corresponding to the selected icon. For example, the user may change the flash mode setting by selecting the icon 21 representing the flash mode setting displayed on the live view image, may change the color setting to a white balance setting by selecting the icon 22 representing the color setting, and may change the storage time setting by selecting the icon 12 representing the storage time setting. Also, the user may change a photographing mode setting, which is not displayed on the live view image, to a burst photographing mode by accessing a function menu.

When such a user command is input via the input unit 120, the control unit 140 generates icons representing changed function settings, and controls the display unit 130 to display the generated icons on a second region 40, which is a predetermined region of the live view image. The control unit 140 may control the display unit 130 to sequentially display the icons representing the changed function settings on the second region 40 in the order in which the function settings were changed. Specifically, the control unit 140 may store time information regarding a point of time when each of the function settings was changed according to the user command, in the storage unit 150. Thus, the control unit 140 may control the display unit 130 to display the icons representing the changed function settings on the second region 40, based on the time information stored in the storage unit 150.

The function settings may be changed in the order of a flash mode setting, a burst photographing mode setting, a color setting, and a storage time setting according to a user command. In this case, when displaying of the live view image begins, the control unit 140 may control the display unit 130 to display the icons 41 to 44 representing the changed function settings on the second region 40, based on the time information stored in the storage unit 150. As illustrated in FIG. 4, according to such a control command, the display unit 130 may display the icon 41 indicating that the flash mode setting is changed, the icon 42 indicating that a burst photographing mode is set, an icon 43 indicating that a white balance setting is set, and an icon 44 indicating that the storage time setting is changed, on the second region 40 of the live view image, based on the time information.

As described above, the photographing apparatus may display the icons 11, 12, 21, 22, and 23 representing the function settings on the first regions 10 and 20 of the live view image, and may display the icons 41 to 44 indicating the changed function settings on the second region 40 of the live view image, thereby enabling a user to easily check the function settings that were changed.

If a selection command is input from a user while the icons 11, 12, 21, 22, and 23 representing the function settings are displayed on the first regions 10 and 20 and the icons 41 to 44 representing the changed function settings are displayed on the second region 40, then the control unit 140 performs an operation corresponding to the selection command. An operation of performing an additional function related to at least one of a plurality of icons displayed on first and second regions of a live view image according to a selection command input from a user will now be described in detail.

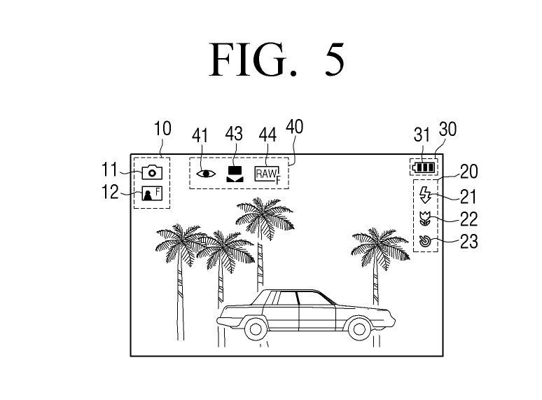

FIG. 5 is a diagram illustrating performing an additional function related to at least one of a plurality of icons displayed on a live view image of a photographing apparatus, according to an embodiment.

As described above with reference to FIG. 4, the display unit 130 may display a plurality of icons 11, 12, 21, 22, and 23 representing function settings on first regions 10 and 20 of a live view image, and may display a plurality of icons 41 to 44 indicating changed function settings on a second region 40 of the live view image. Then, when a selection command instructing selection of one icon from the plurality of icons 11, 12, 21, 22, and 23 displayed on the first regions 10 and 20 and the plurality of icons 41 to 44 displayed on the second region 40 is input, the control unit 140 may control the display unit 130 to stop displaying, or to not display, the icon corresponding to the selection command on the live view image.

More specifically, when a selection command instructing the selection of the icon 42 indicating that a photographing mode setting is changed to a burst photographing mode from the plurality of icons 41 to 44 displayed on the second region 40 is input from a user, the control unit 140 controls the display unit 130 to stop displaying the icon 42 on the live view image. Thus, as illustrated in FIG. 5, the display unit 130 may display the remaining icons 41, 43, and 44, but not the icon 42 indicating that the photographing mode setting is changed to the burst photographing mode.

According to an another embodiment, when a selection command instructing the selection of at least one icon from the icons 41 to 44 displayed on the second region 40 is input via the input unit 120, the control unit 140 may initialize, or reset, a setting corresponding to the least one icon corresponding to the selection command. Specifically, when a selection command instructing the selection of the icon 42 indicating that the photographing mode setting is changed to the burst photographing mode from the plurality of icons 41 to 44 displayed on the second region 40 is input from a user, the control unit 140 initializes or resets the setting corresponding to the icon 42 displayed on the second region 40 to have a default value. Then, the control unit 140 controls the display unit 130 to stop displaying the initialized icon 42 on the second region 40 of the live view image as described above. Thus, the display unit 130 may display the remaining icons 41, 43, and 44, but not the icon 42 indicating that the photographing mode setting has been changed to the burst photographing mode, on the second region 40.

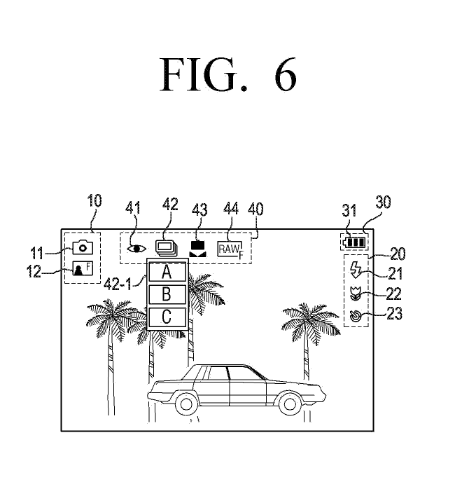

FIG. 6 is a diagram illustrating performing an additional function related to at least one of a plurality of icons displayed on a live view image on a photographing apparatus, according to another embodiment.

As illustrated in FIG. 6, the display unit 130 may display a plurality of icons 11, 12, 21, 22, and 23 representing function settings on first regions 10 and 20 of a live view image and may display a plurality of icons 41 to 44 representing changed function settings, on a second region 40 of the live view image. Then, when a selection command instructing the selection of an icon from the plurality of icons 11, 12, 21, 22, and 23 displayed on the first regions 10 and 20 and the plurality of icons 41 to 44 displayed on the second region 40 is input, the control unit 140 may control the display unit 130 to display a function setting menu list for the icon corresponding to the selection command.

Specifically, when a selection command instructing the selection of the icon 42 indicating that a photographing mode setting is changed to a burst photographing mode from the plurality of icons 41 to 44 displayed on the second region 40 is input from a user, the control unit 140 may control the display unit 130 to display a function setting menu list 42-1 for the icon 42 displayed on the second region 40. According to such a control command, the display unit 130 may display the function setting menu list 42-1 for the icon 42 indicating that the photographing mode setting is changed to the burst photographing mode, on the live view image.

Then, when a selection command instructing the selection of one of items A, B, and C included in the function setting menu list 42-1 is input from a user, the control unit 140 changes the burst photographing mode to a photographing mode represented by the item corresponding to the selection command, and controls the display unit 130 to display an icon indicating the changed photographing mode. Thus, the display unit 130 may display the icon indicating that the burst photographing mode for the icon 42 displayed on the second region 40 has been changed to the photographing mode represented by the item corresponding to the selection command.

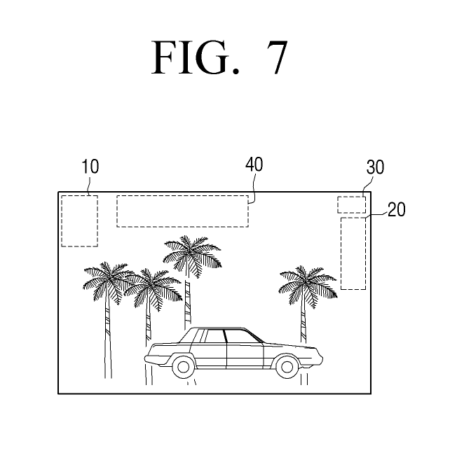

FIG. 7 is a diagram illustrating performing an additional function according to a command instructing the selection of a remaining region of a live view image different from a first region and a second region, on a photographing apparatus, according to another embodiment.

As described above with reference to FIG. 4, the display unit 130 may display a plurality of icons 11, 12, 21, 22, and 23 representing function settings on first regions 10 and 20 of a live view image, and may display a plurality of icons 41 to 44 indicating changed function settings on a second region 40 of the live view image. Then, according to an embodiment, when a selection command instructing the selection of a remaining region of the live view image different from the first regions 10 and 20 and the second region 40, is input from a user, the control unit 140 may control the display unit 130 to stop displaying, or not to display, the plurality of icons 11, 12, 21, 22, and 23 on the first regions 10 and 20 and the plurality of icons 41 to 44 on the second region 40 on the live view image according to the selection command.

According to an embodiment, when the selection command instructing the selection of the remaining region of the live view image different from the first regions 10 and 20 and the second region 40, is input from the user via the input unit 120, the control unit 140 may control the display unit to stop displaying, or not display, the icons displayed on the remaining region on the live view image, except for an icon displayed on a region corresponding to a preset condition stored in the storage unit 150. For example, the region corresponding to the preset condition may be the second region 40 on which the plurality of icons 41 to 44 indicating the changed function settings are displayed. In this case, the control unit 140 may control the display unit 130 to stop displaying the plurality of icons 11, 12, 21, 22, and 23 on the first regions 10 and 20 on the live view image.

According to another embodiment, when a selection command instructing the selection of either the first regions 10 and 20 or the second region 40 is input from a user via the input unit 120, the control unit 140 may control the display unit 130 to stop displaying the icons included in the region corresponding to the selection command on the live view image. For example, when the selection command instructs to select the first regions 10 and 20, the control unit 140 may control the display unit 130 to stop displaying the icons 11, 12, 21, 22, and 23, so that only the icons 41 to 44 on the second region 40 are displayed on the live view image.

According to such a control command, the display unit 130 may stop displaying the icons that were displayed on the first regions 10 and 20 and the second region 40 of the live view image; may stop displaying icons that were displayed on a remaining region of the live view image, except for a region corresponding to a preset condition; or may stop displaying icons that were displayed on a remaining region of the live view image, except for a region corresponding to a selection command from the user, as illustrated in FIG. 7. As described above, the display unit 130 may stop displaying at least one icon of a plurality of icons displayed on the live view image from the live view image according to the control command from a user, so that a user can view an image displayed on the live view image without being obstructed by the icons displayed on the live view image.

After the display unit 130 has stopped displaying icons that were displayed on at least one region of the live view image according to a previous selection command, if a selection command instructing the selection of the remaining region of the live view image different from the first regions 10 and 20 and the second region 40 is input from a user, then the display unit 130 may redisplay (or cancel the removal of) all of the icons from the live view image, so that all of the icons may be displayed on the live view image, under control of the control unit 140.

The operation of providing the icons representing the function settings of the photographing apparatus and the icons indicating the changed function settings, performed by the photographing apparatus, has been described above in detail. A method of providing icons representing function settings of a photographing apparatus and icons indicating changed function settings in the photographing apparatus according to an embodiment will now be described in greater detail.

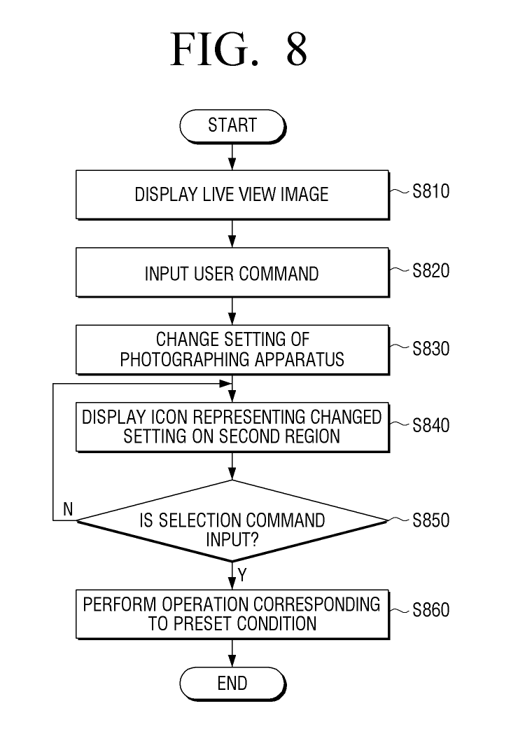

FIG. 8 is a flowchart illustrating a method of providing icons representing function settings on a live view image displayed on a photographing apparatus, according to an embodiment.

Referring to FIG. 8, the photographing apparatus displays a live view image according to a user command, and displays an image of an object, which is to be photographed, on the live view image (operation S810). While displaying of the live view image, the photographing apparatus displays at least one icon corresponding to settings of the photographing apparatus on a first region of the live view image. Specifically, as described above with reference to FIG. 3, the photographing apparatus may display a plurality of icons representing function settings on first regions, i.e., left and right regions, of the live view image. According to an embodiment, an icon representing image shooting type and an icon representing a storage time setting among the plurality of icons representing the function settings may be displayed on the left region among the first regions, and an icon representing a flash mode setting, an icon representing a color setting, and an icon representing an automatic shutter setting may be displayed on the right region. The function settings corresponding to the plurality of icons displayed on the left and right regions may be initialized, or reset, to have default values.

When a user command instructing a change to the settings of the photographing apparatus is input while the image and the plurality of icons representing the function settings of the photographing apparatus are displayed on the live view image (operations S820), the photographing apparatus changes the settings of the photographing apparatus according to the user command (operation S830). Then, the photographing apparatus generates icons representing the changed function settings and displays the generated icons on a second region, which is a predetermined region of the live view image (operation S840).

According to an embodiment, when a setting corresponding to one of at least one icon displayed on the first regions of the live view image is changed according to an input user command, the photographing apparatus may display an icon representing the changed setting on the second region, which is a region different from the first regions. The icon representing the changed setting may be different from the at least one icon displayed on the first regions.

According to another embodiment, when a setting corresponding to an icon that is not displayed on the first regions is changed according to an input user command, the photographing apparatus may generate an icon representing the changed setting and display this generated icon on the second region, which is a region different from the first regions.

For example, when a user changes a flash mode setting by selecting an icon representing the flash mode setting and is displayed on one of the first regions of the live view image, the photographing apparatus may generate an icon representing the changed flash mode setting, which is different from the icon representing the flash mode setting already displayed on one of the first regions, and display the generated icon representing the changed flash mode setting on the second region. On the other hand, the user may access a function menu and change a photographing mode setting that is not displayed on the first regions to a burst photographing mode. In this case, the photographing apparatus may generate an icon indicating that the photographing mode setting has been changed to the burst photographing mode, and display this generated icon on the second region.

In order to display icons representing changed settings on the second region of the live view image, the photographing apparatus may sequentially display these icons on the second region in the order in which the settings corresponding to these icons were changed. For example, as described above with reference to FIG. 4, function settings may be changed such that a flash mode setting, a burst photographing mode setting, a color setting, and a storage time setting are sequentially changed according to a user command. In this case, when the displaying of a live view image begins, the photographing apparatus may display the icons representing the changed settings on the second region, based on time information corresponding to points of time when the function settings were changed.

As described above, the photographing apparatus may display icons representing function settings on a first region of a live view image and display icons representing changed function settings on a second region of the live view image, so that a user may easily check the changed function settings.

Then, the photographing apparatus determines whether a selection command is input from a user while the icons representing the function settings are displayed on the first regions and the icons representing the changed function settings are displayed on the second region (operation S850). If a selection command has been input (Y), then the photographing apparatus performs an operation corresponding to a preset condition, according to the selection command (operation S860). If a selection comment has not been input (N), then the photographing apparatus displays the icons representing the function settings on the first regions and the icons representing the changed function settings on the second region (operation S840).

According to an embodiment, when a selection command instructing the selection of at least one icon displayed on the second region of the live view image is input, the photographing apparatus initializes, or resets, a setting corresponding to the at least one icon corresponding to the selection command. Specifically, as described above with reference to FIG. 4, a plurality of icons may be displayed on the second region, and the selection command may instruct the selection of an icon indicating that the photographing mode setting has been changed to the burst photographing mode among the plurality of icons. When the selection command is input, the photographing apparatus initializes, or resets, a setting corresponding to this icon to have a default value. Then, the photographing apparatus stops displaying the initialized icon on the second region of the live view image. Thus, the photographing apparatus may display the remaining icons, but not the icon indicating that the photographing mode setting has been changed to the burst photographing mode, on the second region.

According to another embodiment, when the selection command instructing the selection of at least one icon displayed on the second region is input, the photographing apparatus may display a function setting menu list related to the at least one icon corresponding to the selection command, on the live view image.

As described above with reference to FIG. 6, a plurality of icons representing changed function settings may be displayed on a second region of a live view image, and a selection command instructing the selection of an icon indicating that a photographing mode setting has been changed to a burst shooting mode among the plurality of icons may be input from a user. When the selection command is input, the photographing apparatus may display a function setting menu list related to the icon indicating that the photographing mode setting has been changed to the burst photographing mode, on the live view image. Then, when a selection command instructing the selection of one of items A, B, and C included in the function setting menu list is input from the user, the photographing apparatus may change the photographing mode setting from the burst photographing mode to a photographing mode corresponding to the selected item, and display an icon representing the changed photographing mode. Thus, the photographing apparatus may display an icon indicating that the burst photographing mode is changed to the photographing mode corresponding to the item selected according to the selection command, instead of the icon that represents the burst photographing mode that is displayed on the second region.

According to another embodiment, when a selection command instructing the selection of a remaining region of the live view image different the first and second regions is input, the photographing apparatus may stop displaying the icons on the first and second regions. As described above with reference to FIG. 4, a plurality of icons representing function settings may be displayed on first regions of a live view image, and a plurality of icons representing changed function settings may be displayed on a second region of the live view image. When a selection command instructing the selection of a remaining region of the live view image different from the first and second regions is input from a user, the photographing apparatus stops displaying all of the icons on the first and second regions, so the icons are no longer displayed on the live view image.

According to another embodiment, when the selection command instructing the selection of the remaining region of the live view image different from the first and second regions is input, the photographing apparatus may stop displaying all of the icons on the first and second regions except for an icon corresponding to a preset condition. For example, a region corresponding to the preset condition may be the second region on which the icons representing the changed function settings are displayed. In this case, the photographing apparatus may display only the icons in the second region, and stop displaying the icons on the first region, on the live view image.

According to another embodiment, when a selection command instructing the selection of at least one region from the first and second regions is input, the photographing apparatus may stop displaying icons on the at least one region corresponding to the selection command. For example, when a selection command instructing the selection of the first regions is input from a user, the photographing apparatus may display only the icons displayed on the second region, on the live view image. On the other hand, when a selection command instructing the selection of the second region is input from the user, the photographing apparatus may display only the icons displayed on the first regions, on the live view image.

As described above, the photographing apparatus may stop displaying the icons displayed on the first and second regions of the live view image; may stop displaying icons displayed on a remaining region of the live view image, except for a region corresponding to a preset condition; or may stop displaying icons displayed on a remaining region of the live view image, except for a region corresponding to a selection command from a user. As described above, the photographing apparatus may stop displaying at least one of a plurality of icons that was displayed on the live view image according to a control command input from a user, so that the user may view an image displayed on the live view image without being obstructed by the plurality of icons that were displayed on the live view image.

After the photographing apparatus has stopped displaying icons on at least one region of the live view image according to a previous selection command from the user, if a selection command instructing the selection of a remaining region of the live view image different from the first and second regions is input from a user, then the photographing apparatus may redisplay (or cancel the removal of) all of the icons on the live view image, so that all of the icons may be displayed on the live view image.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

The foregoing exemplary embodiments and advantages are merely exemplary and are not to be construed as limiting the invention. The present teaching can be readily applied to other types of apparatuses. Also, the description of the exemplary embodiments of the invention is intended to be illustrative, and not to limit the scope of the claims, and many alternatives, modifications, and variations will be apparent to those skilled in the art.

What is claimed is:

1. A photographing apparatus comprising:
a display unit which displays an image;
an input unit via which a command is input; and
a control unit which controls the display unit to display changed-setting icons representing changed settings of the photographing apparatus on a predetermined region of the display unit, when settings of the photographing apparatus are changed according to an input command.

2. The photographing apparatus as claimed in claim 1, wherein, while a live view image is displayed, the display unit displays at least one setting icon corresponding to a setting of the photographing apparatus on a first region of the live view image, and
when a setting corresponding to one of the at least one setting icon displayed on the first region is changed according to an input command, the control unit controls the display unit to display a changed-setting icon representing the changed setting on a second region of the live view image, the second region being different from the first region.

3. The photographing apparatus as claimed in claim 1, wherein, while a live view image is displayed, the display unit displays at least one setting icon corresponding to a setting of the photographing apparatus on a first region of the live view image, and
when a setting corresponding to an icon that is not displayed on the first region is changed according to an input command, the control unit generates a changed-setting icon representing the changed setting and controls the display unit to display the generated changed-setting icon on a second region of the live view image, the second region being different from the first region.

4. The photographing apparatus as claimed in claim 2, wherein the control unit controls the display unit to display a plurality of changed-setting icons representing changed settings on the second region, in the order in which the settings have been changed.

5. The photographing apparatus as claimed in claim 2, wherein, when a selection command instructing selection of at least one changed-setting icon displayed on the second region is input, the control unit initializes a setting of the at least one changed-setting icon displayed in the second region corresponding to the selection command.

6. The photographing apparatus as claimed in claim 2, wherein, when a selection command instructing selection of at least one changed-setting icon displayed on the second region is input, the control unit controls the display unit to display a function setting menu list related to the at least one changed-setting icon displayed in the second region corresponding to the selection command.

7. The photographing apparatus as claimed in claim 2, wherein, when a selection command instructing selection of a remaining region of the live view image different from the first and second regions is input, the control unit controls the display unit to stop displaying the icons that are displayed on the first and second regions.

8. The photographing apparatus as claimed in claim 2, wherein, when a selection command instructing selection of a remaining region of the live view image different from the first and second regions is input, the control unit controls the display unit to stop displaying the icons that are displayed on the first and second regions, except for an icon corresponding to a preset condition.

9. The photographing apparatus as claimed in claim 2, wherein, when a selection command instructing selection of at least one of the first and second regions is input, the control unit controls the display unit to stop displaying icons that are displayed on the at least one region corresponding to the selection command.

10. The photographing apparatus as claimed in claim 7, wherein, after the display unit has stopped displaying at least one icon of the icons displayed in the first and second regions according to the input command, when a second selection command instructing selection of the remaining region of the live view image is input, the control unit controls the display unit to redisplay the at least one icon.

11. A method of controlling a photographing apparatus, the method comprising:
receiving an input command;
changing settings of the photographing apparatus according to the input command;
generating changed-setting icons representing the changed settings; and
displaying the changed-setting icons on a predetermined region of a display unit.

12. The method as claimed in claim 11, further comprising:
while displaying a live view image, displaying at least one setting icon corresponding to a setting of the photographing apparatus on a first region of the live view image, and
wherein when a setting corresponding to one of the at least one setting icon displayed on the first region is changed according to the input command, the displaying of the changed-setting icons on the predetermined region comprises displaying a changed-setting icon representing the changed setting on a second region of the live view image, the second region being different from the first region.

13. The method as claimed in claim 11, further comprising:
while displaying a live view image, displaying at least one setting icon corresponding to settings of the photographing apparatus on a first region of the live view image, and
wherein when a setting corresponding to an icon that is not displayed on the first region is changed according to the input command, the displaying of the changed-setting icons on the predetermined region comprises:
generating a changed-setting icon representing the changed setting, and
displaying the generated changed-setting icon on a second region of the live view image, the second region being different from the first region.

14. The method as claimed in claim 12, wherein the displaying of the changed-setting icons on the predetermined region comprises displaying the changed-setting icons on the second region, in the order in which the settings have been changed.

15. The method as claimed in claim 12, further comprising:
when a selection command instructing selection of at least one changed-setting icon displayed on the second region is input, initializing a setting of the at least one changed-setting icon corresponding to the selection command.

16. The method as claimed in claim 12, further comprising:
when a selection command instructing selection of at least one changed-setting icon displayed on the second region is input, displaying a function setting menu list related to the at least one changed-setting icon corresponding to the selection command.

17. The method as claimed in claim 12, further comprising:
when a selection command instructing selection of a remaining region of the live view image different from the first and second regions is input, stop displaying the icons that are displayed on the first and second regions.

18. The method as claimed in claim 12, further comprising:
when a selection command instructing selection of a remaining region of the live view image different from the first and second regions is input, stop displaying the icons that are displayed on the first and second regions, except for an icon corresponding to a preset condition.

19. The method as claimed in claim 12, further comprising:
when a selection command instructing selection of at least one of the first and second regions is input, stop displaying icons that are displayed on the at least one region corresponding to the selection command.

20. The method as claimed in claim 17, further comprising:
after at least one icon of the icons on the first and second regions is no longer displayed on the live view image according to the selection command, when a second selection command instructing selection of the remaining region of the live view image is input, redisplaying the at least one icon.
